(19) United States
(12) Patent Application Publication
(10) Pub. No.: US 2002/0139723 A1
(43) Pub. Date: Oct. 3, 2002

(54) Pressure screen to remove impurities from a paper fiber suspension containing impurities and its use

(75) Inventors: Michael Danger, Salem (DE); Reimund Rienecker, Heidenheim (DE); Samuel Schabel, Ravensburg (DE)

Correspondence Address: GREENBLUM & BERNSTEIN, P.L.C., 1941 ROLAND CLARKE PLACE, RESTON, VA, 20191, US

(73) Assignee: VOITH PAPER PATENT GmbH, Heidenheim (DE)

(21) Appl. No.: 10/096,901

(22) Filed: Mar. 14, 2002

(30) Foreign Application Priority Data
Mar. 28, 2001 (DE) 101 15 298.1

(51) Int. Cl. B07B 1/04

(52) U.S. Cl. 209/273; 209/270; 209/283; 209/306; 210/414

(57) ABSTRACT

Pressure screen to remove impurities from a paper fiber suspension that contains impurities. Pressure screen includes a housing having at least one inflow fitting, at least one accept outflow fitting and at least one reject outflow, and at least first and second cylindrical wires located within housing. The at least first and second wires are arranged to be consecutively flowed through by paper fiber suspension, which is introduced into housing through inflow fitting. A first accept, including a portion of paper fiber suspension that passes through first wire, flows toward second wire, and a second accept, including a portion of paper fiber suspension that passes through second wire, flows out of housing through accept outflow. The at least first and second wires are arranged within housing so that paper fiber suspension is fed radially through the at least first and second wires from an inside to an outside.

### CROSS-REFERENCE TO RELATED APPLICATIONS

The present application claims priority under 35 U.S.C. §119 of German Patent Application No. 101 15 298.1, filed on Mar. 28, 2001, the disclosure of which is expressly incorporated by reference herein in its entirety.

### BACKGROUND OF THE INVENTION

1. Field of the Invention

The invention relates to a pressure screen to remove impurities from a paper fiber suspension that contains impurities. The pressure screen includes a housing containing at least two cylindrical wires, in which the housing has at least one inflow fitting, at least one accept outflow fitting and at least one reject outflow. Further, the wires are arranged such that they can be flowed through consecutively by the paper fiber suspension that is introduced into the housing through the inflow fitting, and by the portion of the paper fiber suspension that has passed through the first wire as a first accept being able to flow toward the second wire. In this way, the portion of the paper fiber suspension that has also passed through the second wire is guided out of the housing again through the accept outflow as the second accept.

2. Discussion of Background Information

Pressure screens are used to prepare paper fiber suspensions and, namely, to process the fibrous suspension in a wet screening. To do this, this type of pressure screen contains at least one wire that is provided with a multiplicity of openings. The fibers contained in the suspension are intended to move through the openings while the undesired solid components are rejected and guided out of the screen again. Pressure screens can also be used for fiber fractionation whereby the long fibers are concentrated in the overflow and the short fibers in the throughput. As a rule, round holes or slots are used as screen openings. In most cases, pressure screens of the type considered here are equipped with wire clearers, which are moved closely past the wire. Clogging of the screen openings is thus avoided in a manner known per se.

It is known that the pressure screens can basically be used to sort out both relatively coarse as well as very fine impurities. Such pressure screens are oriented to the respective intended purpose in this regard not just by the selection of the wires themselves and particularly their openings, but also by the structural design of the machine and the selection of the operating parameters. It has become possible to successfully manufacture wires with very fine openings, e.g., slots in the range of tenths of millimeters, at justifiable expense. As a result, it is also possible to separate very small impurities from the fibers. However, this per se positive development has resulted in the wires and, therefore, also the screening apparatuses becoming larger and larger. The number of stages, i.e., the number of pressure screens that the paper fiber suspension must pass through consecutively, has also increased.

A vertical separator for a fibrous suspension, which has two wire elements in a single machine, is known from DE 197 02 044 C1. In the case of this separator, the flow stock to be screened first arrives in the area of a flat preliminary wire, which is kept free by a clearer on the infeed side. The throughput through this flat preliminary wire is then guided into the inside of a rotationally symmetrical wire basket through the openings of which the accept passes so that the suspended paper fibers can pass through this wire basket into the accept outflow. This type of screen should be used especially when the supplied fibrous suspension is mixed with a larger quantity of coarse impurities. As is known, this occurs in recovered paper treatment where the stock originates directly from the pulper or after passing through a cleaning device that removes only the coarsest impurities. This known screen has been optimized for eliminating coarse impurities. The free wire area is relatively small.

WO 00/58549 A1 shows a screen with a vertical housing in which two wire elements are located, which are flowed through consecutively by the paper fiber suspension to be cleaned. The two wire elements are at least partially telescoped axially, making a compact design possible. This screen, too, is intended for coarse screening. Therefore, a rotary driven wire basket is intended to reduce wear, something which makes the machine complicated and expensive.

In another pressure screen according to EP 0 955 406 A2, two cylindrical wire baskets are stacked. The suspension to be screened is guided within the housing such that first a rotating coarse wire (“knotter”) is flowed through from the outside to the inside and then a fixed primary wire is flowed through from the inside to the outside. The throughput through the primary wire should evidently be regarded as the accept of this screen, while the overflow from the primary wire is fed to a so-called secondary wire. This machine, too, is relatively expensive. It is unfavorable for achieving a high degree of purity with a large throughput.

A pressure screen with two or three wire baskets is also known from U.S. Pat. No. 5,622,267. In the cases in which the wire baskets are connected such that the throughput through the upstream wire is guided into the infeed of the downstream wire, the flow in the upstream wire is guided from the radial outside to the radial inside (centripetally). A relatively high construction cost is entailed here, which is no doubt justified if this machine is intended to be used for a fibrous suspension with a high proportion of coarse stock.

In the case of the machine disclosed in EP 0 795 641 A1, the fibrous suspension is also first fed into a wire that is flowed through centripetally, which is then followed by another centripetal wire. This machine, too, is probably intended more for screening coarse stock. It is expensive and evidently can be operated satisfactorily only with intermediate dilution.

### SUMMARY OF THE INVENTION

The present invention is directed to constructing a pressure screen in such a way that it is compact and has a good separating effect even with fine impurities while permitting a relatively high throughput.

In particular, a pressure screen, similar in general that discussed above, is arranged such that the paper fiber suspension that is fed into the housing is fed radially through two cylindrical wires from the inside to the outside.

A pressure screen embodied in this manner offers the advantage that several—but at least two—screening processes can be performed consecutively in one and the same housing. An optimum screening quality is thus achieved with high throughput, since the flow guidance in the screen is selected such that the wire baskets are flowed through centrifugally, i.e., radially from the inside to the outside. A serial connection of highly effective screens is otherwise possible only at considerable expense in mechanical and control engineering terms. With the invention, the number of pressure screens can be substantially reduced even when there are high quality requirements. A pressure screen according to the invention offers special advantages for fine screening. Wherever one is dealing with removing particularly fine impurities in fibrous material processing (normally slot screening is performed here), the pressure screens used must be relatively large. This is the only way that adequate throughputs can be conveyed in an operationally safe manner given the fineness of the screen openings.

The invention exhibits its advantages especially when the successively connected wires are fine wires and have approximately the same screening characteristics, i.e., they screen in the same size range. This is especially the case if the wires are provided with similar or the same slots, namely, with a slot width of a maximum of about 0.8 mm, preferably less than about 0.3 mm. It has been shown that in technical applications the screening of a single stage is often not sufficient for the required quality, particularly if the impurities are present in the same order of magnitude as the fibers, and, therefore, can pass through the screen with some probability. This also applies to the per se highly effective pressure screens with slot wire baskets. The critical impurities are primarily adhering particles (stickies). This problem cannot be solved by narrower screen openings. As a result, a further screening step acting in the same way must be undertaken with the stock that has already been cleaned in order to increase the probability of eliminating stock that is difficult to screen.

However, in addition to the process control aspects under which this type of pressure screen must be designed, there are also other requirements, e.g., the ease of opening such machines and good accessibility of the wires. This is important because they have to be removed or cleaned occasionally. Structural solutions that concretely relate to the arrangement of the wires and keeping them clear as well as guiding the stock flows will be described below.

When using the pressure screen according to the invention, it can be particularly advantageous if the reject rate on the upstream wire is adjusted to be significantly higher than on the downstream wire. The reject rate here is the volumetric proportion of the overflow related to the infeed to the corresponding wire. Due to the higher content of impurities in the infeed to the upstream wire, a reject rate that is approximately double that of the downstream wire can be set there.

The instant invention is directed to a pressure screen to remove impurities from a paper fiber suspension that contains impurities. The pressure screen includes a housing having at least one inflow fitting, at least one accept outflow fitting and at least one reject outflow, and at least first and second cylindrical wires located within the housing. The at least first and second wires are arranged to be consecutively flowed through by the paper fiber suspension, which is introduced into the housing through the inflow fitting. A first accept, including a portion of the paper fiber suspension that passes through the first wire, flows toward the second wire, and a second accept, including a portion of the paper fiber suspension that passes through the second wire, flows out of the housing through the accept outflow. The at least first and second wires are arranged within the housing so that the paper fiber suspension is fed radially through the at least first and second wires from an inside to an outside.

According to a feature of the instant invention, the at least first and second wires are composed of exactly two cylindrical wire baskets.

In accordance another feature of the invention, the at least first and second wires may include slot-shaped screen openings. Further, a slot width of the slot-shaped screen openings can be a maximum of about 0.8 mm, and the slot width can be a maximum of about 0.3 mm.

According to still another feature of the present invention, a screening effect can be approximately the same with each of the at least first and second wires.

Further, the at least first and second wires may be coaxially arranged. A rotating wire clearer with clearing elements can be provided, and the at least first and second two wires may be kept free of obstructions by the rotating wire clearer such that the clearing elements pass by a surface of the at least first and second wires at a close distance. Moreover, a single rotating wire clearer with clearing elements can be provided such that the at least first and second two wires are kept free of obstructions by the single rotating wire clearer such that the clearing elements pass by a surface of the at least first and second wires at a close distance. A wire clearer drive may be included, such that a one of the at least first and second wire positioned closer to the wire clearer drive has a greater diameter than an other of the at least first and second wire.

In accordance with a further feature of the instant invention, the at least one reject outflow may include at least two reject outflows, such that at least one reject outflow is associated with each of the at least first and second wires to guide residue out of a respective wire.

The at least one reject outflow may be common to the at least one first and second wires to guide residues out of the first and second wires. Further, a throttle element can be positioned between reject areas of the first and second wires. The throttle element may be adjustable.

Moreover, the first wire may be arranged axially outside of an area in which the second wire is located. The accept outflow fitting of an upstream one of the at least first and second wire may be connected to an intermediate inflow on the housing leading to an infeed side of a downstream one of the at least first and second wire. The housing may have no internal connection between an accept area of the upstream wire and an infeed area of the downstream wire. The accept outflow can be arranged radially on an outside of the upstream wire and the intermediate inflow can be arranged centrally. Further, the accept outflow fitting may be connected externally to the intermediate outflow on the housing. The external connection may include a pump-free pipeline. Still further, a rotor can have an upper face with pump blades, and the rotor may be structured and arranged as a wire clearer.

According to still further feature of the present invention, the at least first and second wires may not be rotatable.

The first wire can be arranged axially within an area in which the second wire is located. Further, one of the at least first and second wires can be rotatable.

The present invention is directed to a process of removing impurities from a paper fiber suspension containing impurities in an apparatus that includes a housing having at least one inflow fitting, at least one accept outflow fitting and at least one reject outflow, and at least first and second cylindrical wires located within the housing. The process includes supplying the paper fiber suspension into the housing through the inflow fitting and consecutively feeding the paper suspension radially through the at least first and second wires from an inside to an outside.

In accordance with a feature of the invention, a consistency of the supplied paper fiber suspension can be between about 1-3% and the paper fiber suspension may be free of hard impurities with a dimension of over about 3 mm. The process can further include adjusting a reject rate of the first wire to be at least 1½ times a reject rate of the second wire, and, preferably includes adjusting a reject rate of the first wire to be double a reject rate of the second wire.

The instant invention is directed to a pressure screen to remove impurities from a paper fiber suspension that contains impurities. The pressure screen includes a first cylindrical wire having a first interior and a first exterior, a second cylindrical wire having a second interior and a second exterior, and a housing structured to contain the first and second cylindrical wires. The housing has an inflow fitting structured to guide the paper fiber suspension into the first interior and the housing has at least one accept outflow fitting positioned at the second exterior to guide accepts passing through the second cylindrical wire.

According to a feature of the invention, the first and second cylindrical wires may be coaxially arranged. Further, the first and second wires can be axially spaced from each other. Further still, the second cylindrical can surround the first cylindrical wire.

Accepts passing through the first cylindrical wire may be guided into the second interior. The first cylindrical wire can be positioned below the second cylindrical wire, and the accepts passing through the first cylindrical wire can be pumped into the second interior. The accepts passing through the first cylindrical wire may be pumped into the second interior at an end of the second cylindrical wire remote from the first cylindrical wire. Further, a throttle may be positioned between the first and second cylindrical wires.

In accordance with still yet another feature of the present invention, the housing can include at least one rejects outflow arranged to receive rejects from the second interior.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates a pressure screen according to the invention with axially offset wire baskets and two reject outflows;

FIG. 2 illustrates a pressure screen similar to that depicted in FIG. 1, but with an external accept line and a common reject outflow;

FIG. 3 illustrates a pressure screen similar to that depicted in FIG. 2 with separate reject discharge;

FIG. 4 illustrates a pressure screen according to the invention with a rotating wire basket;

FIG. 5 illustrates a pressure screen according to the invention with two fixed, axially telescoped wire baskets; and

FIG. 6 illustrates a pressure screen in which the wire baskets are arranged eccentrically in the housing.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

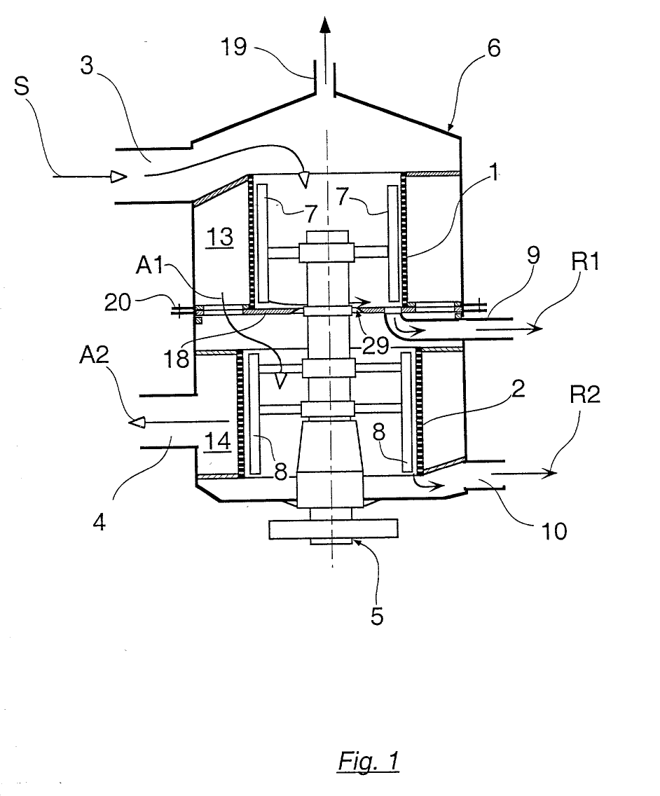

The pressure screen according to the invention shown in diagram form in FIG. 1 has a housing 6 in which two wires are located, namely the first upstream wire 1 and the second downstream wire 2. The pressure screen is constructed in such a way that the paper fiber suspension S flowing in through the upper inflow fitting 3 is first guided to the infeed side of the first wire 1. Clearing elements 7 and 8, which are a part of the wire clearer 5, are located on this infeed side. The wire 1 is kept free of obstructions by the movement of the clearing elements 7 and 8 in a manner that is known per se. After the paper fiber suspension S has passed through the first wire 1 (accept A1), it arrives first in the first accept area 13 and then in the infeed area of the second wire 2. Screening again takes place with this wire so that the portion of the paper fiber suspension that has also passed through the second wire 2 is guided out of housing 6 again through the accept outflow fitting 4 as accept A2. Both wires are flowed through radially from the inside to the outside. The rejected material forms a residue on the first wire 1, which is conducted through the first reject outflow 9 as the first reject R1. A similar process also takes place at the second wire 2, the residue of which exits the housing 6 through the reject outflow 10 as the second reject R2. In cases where the removal of air or light materials is also desired, a central light material connection 19 can be provided.

For the most part, this type of pressure screen is constructed as a vertical screen and has a drive at the bottom for the rotor 5, which is used for wire clearing. It thus allows the housing divider 20 to remove the upper part of the pressure screen. This is required occasionally to make it possible to perform maintenance work on the inside. It is important in this regard that the rotor 5 and the wires 1 and 2 do not prevent it from being pulled apart axially. For this reason, it can be advantageous if the inside diameter of the upper wire 1 is designed to be smaller than that of the wire 2 below it. Another advantage of the arrangement shown here, among others, is that the clearing elements 7 and 8 for both wires 1 and 2 can belong to the same rotor 5.

The infeed areas of both wires are separated from one another by a plate 18, which is sealed free of contact against the rotor 5 by means of an annular gap 29. Only relatively low circumferential speeds occur at the annular gap and the pressure is lower than on the inside of the wire. The plate 18 can be divided for easier disassembly so that the rotor can remain in place if the lower wire needs to be removed.

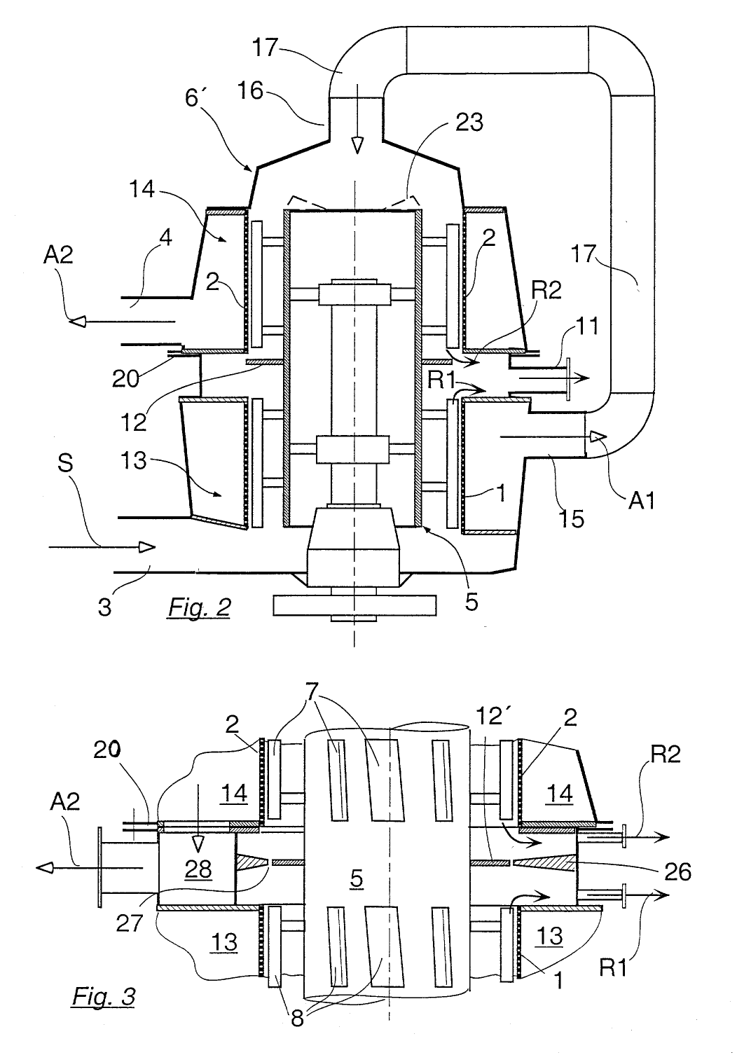

The pressure screen shown in FIG. 2 also has two wires 1 and 2, which are offset axially from one another so far apart that they are located in different areas. In contrast to the screen shown in FIG. 1, in this case, the fibrous suspension S is introduced into the housing 6′ via a lower inflow fitting 3. Therefore, the wire 1 that is flowed through first is down below and the second wire 2 up above. The accept A1, i.e., the throughput through the first wire 1, is guided back out of the first accept area 13 via an external pipeline 17, which in this case is pump-free, into the pressure screen by reaching an intermediate infeed 16, which is located on the upper part of the housing 6′. The suction effect on the centrally situated intermediate infeed 16 can assist the transport of the suspension. At any rate, there is an externally induced pressure gradient between the infeed fitting 3 and the accept outflow fitting 4 when operating the screen. If this excess pressure is intended to equalize the pressure loss of both wires, it can also greatly increase the pressure in the infeed area of the first wire in special cases. In order to make it possible to keep this pressure lower, a booster pump in the pipeline 17 would then be conceivable. Or the wire clearer rotor would be provided with pump blades 23 (drawn with a dotted line) on its upper face, which effect an increase in pressure.

The accept A1 arrives from the intermediate infeed 16 in the infeed area of the second wire 2. Once it has passed through here and has reached the second accept area 14, it can be guided out of the housing through the accept outflow fitting 4 as accept A2. In order to simplify the drawing, the accept outflow fitting 4 is shown in the upper portion of the housing 6′, i.e., above the housing divider 20. It is located advantageously (easy opening of the housing) in the lower portion. Then an accept collection chamber 28 shall be provided there, as shown in FIG. 3. The special structure of this pressure screen makes it possible, if desired, for the two rejects R1 and R2 to be guided out of the housing in a common reject outflow 11. An undesirable mixing of the rejects with the accepts is thereby avoided by this type of design. A blind is provided to control the reject flows, e.g., as part of the wire clearer 5, i.e., rotating along with it. Advantageously, the blind 12 can be adjustable. The wire clearer 5 in this case has a drum-shaped design with mounted clearing elements, which can be similar to the case shown in FIG. 1. However, variations of different clearing elements are also always possible and depend upon the particular circumstances and requirements imposed.

In cases in which the rejects need to be drawn off separately, a separating disk 26 fixed in the housing, as indicated in FIG. 3, is beneficial. With a ring 12′ revolving on the rotor, which is not shown in section here, it forms a sealing gap 27, which is, e.g., approx. 1 to 3 mm wide. The very slight mixing of the two rejects R1 and R2 that occurs as a result is acceptable. This FIG. 3 also shows a variation that has already been mentioned: the accept outflow fitting 4 is located beneath the housing divider 20, which makes it easier to open. The second accept A2 is diverted out of the second accept area 14 into an accept collection chamber 28, which only extends over a small portion of the circumference of the housing. The accept outflow fitting 4 is then attached to this.

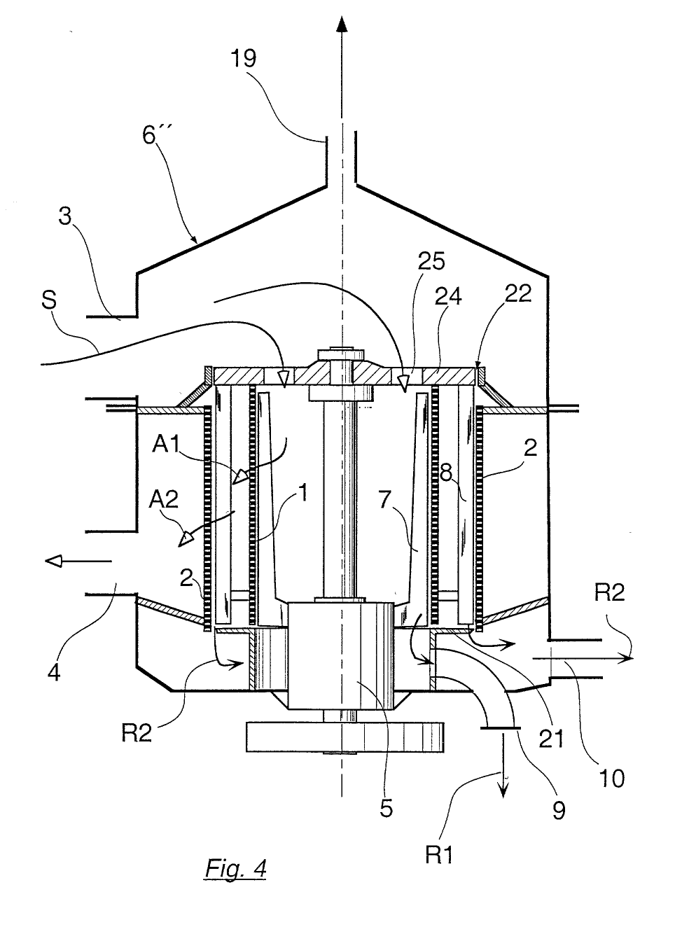

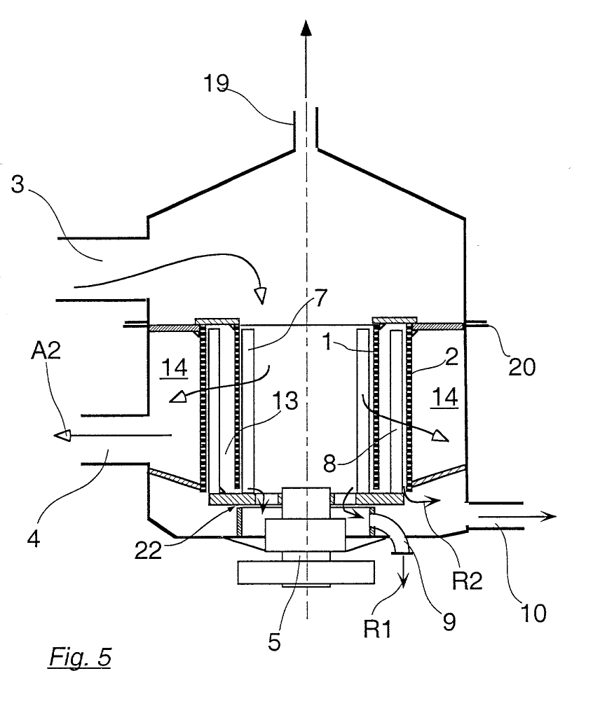

An especially compact and space-saving embodiment of the pressure screen according to the invention is produced if the two wires are axially telescoped, i.e., when they are not located in separate areas. This results in a low housing 6″. Such a design is shown in FIG. 4. With these pressure screens, the introduced fibrous suspension S is introduced from above and guided consecutively through the two wires 1 and 2 radially from the inside to the outside. In this process, the rejects R1 and R2 reach the lower part of the pressure screen and are carried off separately from one another. The embodiment shown here has the special feature of a rotating internal wire basket that serves as the first wire 1. The wire is kept free because the clearing elements 7 belonging to this rotating wire basket are fixed. The clearing elements 8 that are intended to act on the second wire 2 rotate with the same circumferential speed as the rotating wire basket. The first wire 1 and the clearing elements 8 belonging to the second wire 2 are attached to a discoidal plate 24. This forms the upper part of the wire clearer 5 from which it can be removed in the upward direction after opening the housing 6″. The plate 24 contains openings 25 for the incoming paper fiber suspension S. The second wire 2 is fixed in the housing.

As a rule, gaps 22 are adequate at the locations where media-guiding clearers having separating walls that can be moved relative to one another need to be sealed against one another. In special cases, contacting seals should also be provided. A throttle ring 21, which is shown only with respect to its function, is present to prevent short circuit flows between accepts and rejects.

Similar to the embodiment shown in FIG. 4, the one in FIG. 5 also has two axially telescoped wires 1 and 2, which are flowed through from the inside to the outside. However, both wires are fixed, while the clearing elements 7 or 8 are fastened to a common, rotating wire clearer 5. In this case as well, the two rejects R1 and R2 are carried off separately, which has the advantage that the reject flows can be controlled easily by applying different throttling. When this is not required, both reject flows can also be diverted through a common reject fitting.

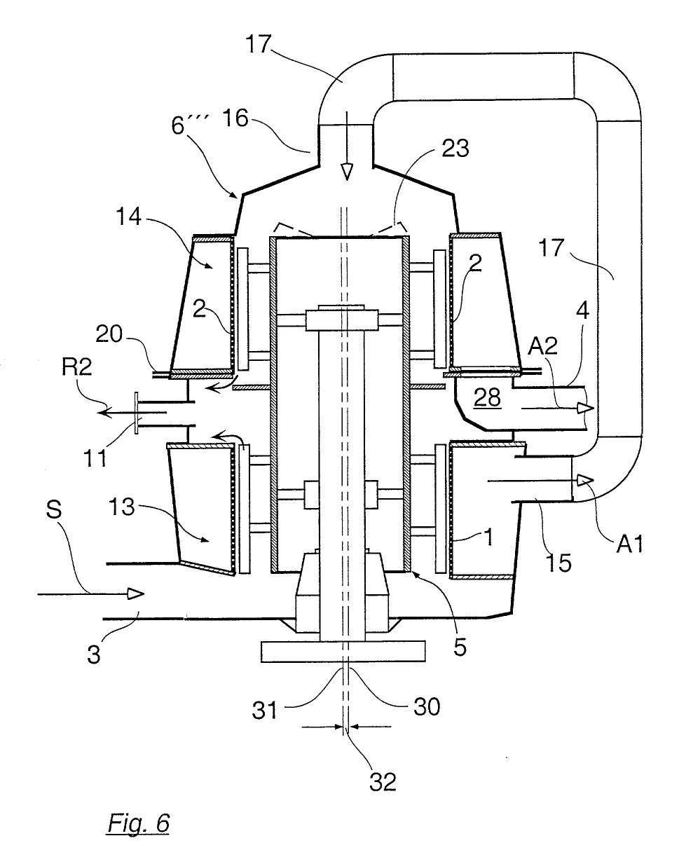

The pressure screen according to FIG. 6 is especially favorable in terms of fluid technology. Here the center line 30 of the housing 6′″ does not coincide with the centerline 31 of rotor 5, whereby this offset enlarges the rotor's distance from the two accept connecting fittings 4 or 15. With simple means, this leads to greater flow cross-sections at areas of larger accept volume flows. This eccentricity 32 can be between approximately 40 and 200 mm depending upon housing size and is advantageously determined such that the flow speed of the accept flows cannot reach unfavorable values anywhere.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A pressure screen to remove impurities from a paper fiber suspension that contains impurities comprising:
a housing comprising at least one inflow fitting, at least one accept outflow fitting and at least one reject outflow;
at least first and second cylindrical wires located within said housing;
said at least first and second wires being arranged to be consecutively flowed through by the paper fiber suspension, which is introduced into the housing through said inflow fitting, wherein a first accept, comprising a portion of the paper fiber suspension that passes through said first wire, flows toward said second wire, and a second accept, comprising a portion of the paper fiber suspension that passes through said second wire, flows out of said housing through said accept outflow; and
said at least first and second wires being arranged within said housing so that the paper fiber suspension is fed radially through said at least first and second wires from an inside to an outside.

2. The pressure screen in accordance with claim 1, wherein said at least first and second wires are composed of exactly two cylindrical wire baskets.

3. The pressure screen in accordance with claim 1, wherein said at least first and second wires comprise slot-shaped screen openings.

4. The pressure screen in accordance with claim 3, wherein a slot width of said slot-shaped screen openings is a maximum of about 0.8 mm.

5. The pressure screen in accordance with claim 4, wherein said slot width is a maximum of about 0.3 mm.

6. The pressure screen in accordance with claim 1, wherein a screening effect is approximately the same with each of said at least first and second wires.

7. The pressure screen in accordance with claim 1, wherein said at least first and second wires are coaxially arranged.

8. The pressure screen in accordance with claim 7, further comprising a rotating wire clearer with clearing elements,
wherein said at least first and second two wires are kept free of obstructions by said rotating wire clearer such that said clearing elements pass by a surface of said at least first and second wires at a close distance.

9. The pressure screen in accordance with claim 7, further comprising a single rotating wire clearer with clearing elements,
wherein said at least first and second two wires are kept free of obstructions by said single rotating wire clearer such that said clearing elements pass by a surface of said at least first and second wires at a close distance.

10. The pressure screen in accordance with claim 8, further comprising a wire clearer drive,
wherein a one of said at least first and second wire positioned closer to said wire clearer drive has a greater diameter than an other of said at least first and second wire.

11. The pressure screen in accordance with claim 1, wherein said at least one reject outflow comprises at least two reject outflows, such that at least one reject outflow is associated with each of said at least first and second wires to guide residue out of a respective wire.

12. The pressure screen in accordance with claim 1, wherein said at least one reject outflow is common to said at least one first and second wires to guide residues out of said first and second wires.

13. The pressure screen in accordance with claim 12, further comprising a throttle element positioned between reject areas of said first and second wires.

14. The pressure screen in accordance with claim 13, wherein said throttle element is adjustable.

15. The pressure screen in accordance with claim 1, wherein said first wire is arranged axially outside of an area in which said second wire is located.

16. The pressure screen in accordance with claim 15, wherein said accept outflow fitting of an upstream one of said at least first and second wire is connected to an intermediate inflow on said housing leading to an infeed side of a downstream one of said at least first and second wire.

17. The pressure screen in accordance with claim 16, wherein said housing has no internal connection between an accept area of said upstream wire and an infeed area of said downstream wire.

18. The pressure screen in accordance with claim 18, wherein said accept outflow is arranged radially on an outside of said upstream wire and said intermediate inflow is arranged centrally.

19. The pressure screen in accordance with claim 16, wherein said accept outflow fitting is connected externally to said intermediate outflow on said housing.

20. The pressure screen in accordance with claim 19, wherein said external connection comprises a pump-free pipeline.

21. The pressure screen in accordance with claim 16, further comprising a rotor having an upper face with pump blades, said rotor being structured and arranged as a wire clearer.

22. The pressure screen in accordance with claim 1, wherein said at least first and second wires are not rotatable.

23. The pressure screen in accordance with claim 1, wherein said first wire is arranged axially within an area in which the second wire is located.

24. The pressure screen in accordance with claim 23, wherein one of said at least first and second wires are rotatable.

25. A process of removing impurities from a paper fiber suspension containing impurities in an apparatus that includes a housing having at least one inflow fitting, at least one accept outflow fitting and at least one reject outflow, and at least first and second cylindrical wires located within the housing, said process comprising:
supplying the paper fiber suspension into the housing through the inflow fitting; and
consecutively feeding the paper suspension radially through the at least first and second wires from an inside to an outside.

26. The process in accordance with claim 25, wherein a consistency of the supplied paper fiber suspension is between about 1-3% and the paper fiber suspension is free of hard impurities with a dimension of over about 3 mm.

27. The process in accordance with claim 26, further comprising:
adjusting a reject rate of the first wire to be at least 1½ times a reject rate of the second wire.

28. The process in accordance with claim 26, further comprising:
adjusting a reject rate of the first wire to be double a reject rate of the second wire.

29. A pressure screen to remove impurities from a paper fiber suspension that contains impurities comprising:
a first cylindrical wire having a first interior and a first exterior;
a second cylindrical wire having a second interior and a second exterior;
a housing structured to contain said first and second cylindrical wires;
said housing having an inflow fitting structured to guide the paper fiber suspension into said first interior; and
said housing having at least one accept outflow fitting positioned at said second exterior to guide accepts passing through said second cylindrical wire.

30. The pressure screen in accordance with claim 29, wherein said first and second cylindrical wires being coaxially arranged.

31. The pressure screen in accordance with claim 30, wherein said first and second wires being axially spaced from each other.

32. The pressure screen in accordance with claim 30, wherein said second cylindrical surrounds said first cylindrical wire.

33. The pressure screen in accordance with claim 29, wherein accepts passing through said first cylindrical wire are guided into said second interior.

34. The pressure screen in accordance with claim 33, wherein said first cylindrical wire is positioned below said second cylindrical wire, and said accepts passing through said first cylindrical wire are pumped into said second interior.

35. The pressure screen in accordance with claim 34, wherein said accepts passing through said first cylindrical wire are pumped into said second interior at an end of said second cylindrical wire remote from said first cylindrical wire.

36. The pressure screen in accordance with claim 34, further comprising a throttle positioned between said first and second cylindrical wires.

37. The pressure screen in accordance with claim 29, wherein said housing comprises at least one rejects outflow arranged to receive rejects from said second interior.
